(19) United States
(12) Patent Application Publication
(10) Pub. No.: US 2004/0117658 A1
(43) Pub. Date: Jun. 17, 2004

(54) Security monitoring and intrusion detection system

(76) Inventor: Andrea Klaes, Konstanz (DE)

Correspondence Address: Michael D. Bednarek, SHAW PITTMAN LLP, 1650 TYSONS BOULEVARD, MCLEAN, VA, 22102, US

(21) Appl. No.: 10/670,298

(22) Filed: Sep. 26, 2003

Related U.S. Application Data
(60) Provisional application No. 60/413,763, filed on Sep. 27, 2002.

(51) Int. Cl. G06F 11/30; G06F 15/173

(52) U.S. Cl. 713/201; 709/224

(57) ABSTRACT

Systems and methods for monitoring a network. Proxy loghosts, each one collecting log files that are generated by resources in a portion of a secure network, generate events in response to the log files collected. A central loghost in communication with the proxy loghosts receives the events from the proxy loghosts, analyzes the events, and determines the necessity of generating an alert and an associated alarm to notify a security manager of a possible intrusion incident, or other anomaly, in the network.

This application claims the benefit of U.S. Provisional Application No. 60/413,763, filed Sep. 27, 2002, which is incorporated herein by reference.

### BACKGROUND

1. Field of the Invention

The present invention relates to computer security monitoring, which is sometimes also referred to as intrusion detection. The present invention also relates, generally, to network/host monitoring.

2. Background of the Invention

Intrusion detection is the process (that involves technology people and tools) of identifying (before, during or after) and responding (by, e.g., terminating service, catching an attacker . . . ) to malicious activity (e.g., vulnerability or error exploits) targeted at computing and networking resources. The ubiquitous nature of computers and their connection to networks makes for a dangerous setting in which malicious persons, with the intent to disrupt and/or cause problems to a selected, or even random, target, can easily practice their “trade.” “Professional” hackers and even “innocent” experimenters can easily undermine computer network availability and security through denial of service (DNS) attacks, worms and viruses. Recent computing history has shown that well-formulated code can easily exploit previously-unknown “holes” in operating systems and other fundamental computing resources.

Several commercial tools have been made available to combat such attacks and to provide more general network monitoring functionality. These tools generally fall into one of two categories: network-based systems and host-based systems.

While these commercial tools may be useful in some contexts, they are often expensive, difficult to implement, and often do not provide all of the information that may be necessary to effectively monitor a network, monitor applications running on or connected to the network, or detect intruders into the network. In particular, these conventional tools are almost universally incapable of monitoring custom applications that may be running independently within a network or that may be running in association with other software applications.

### BRIEF SUMMARY OF THE INVENTION

In view of the deficiencies in prior art monitoring and intrusion detection systems and methods, it is an object of the present invention to provide a more efficient and effective system and method to capture security relevant information.

In its essence, the present invention comprises systems and methods that leverage the availability of system-generated log files in an effort to capture network related issues, problems and events. More specifically, many enterprise software applications, custom applications, network resources, routers, firewalls and the like generate log files for their own respective uses. Typically, log files are generated to facilitate trouble-shooting and to monitor the status of a given resource. In accordance with embodiments of the present invention, log files from substantially all of the resources that generate log files are forwarded to a proxy loghost, where the log files are first preferably configured into a common format and then analyzed for predetermined events.

Event generation may be anomaly-, signature- or knowledge-based. An anomaly causing the generation of an event may be defined by, for example, receiving an excessive number of log files over a selected period of time. An event may be generated in view of a particular signature, i.e., an unusual pattern of log files. Finally, events may generated based on predetermined special events that may be “learned” over time, automatically or by through programming by security personnel. Any such generated events are then forwarded for further analysis, and, when appropriate, an alarm is preferably generated for an operator, whereupon the operator can further investigate the cause of the alarm/event and determine if, in fact, the detected event is one that needs to be acted upon. Action may come in the form of isolating portions of a network, shutting down selected resources, and quarantining data, among others.

In a preferred implementation, the present invention provides for:

collecting security relevant data from different operating systems, platforms and vendors;

collecting security relevant information in real, or near real, time;

identifying critical points, especially external connections, and securing them when appropriate; and

storing security relevant data (especially for subsequent forensic analysis)

These and other features of the present invention and their attendant advantages will be more fully appreciated upon reading the following detailed description in conjunction with the accompanying drawings.

### BRIEF DESCRIPTION OF THE DRAWINGS

FIG. 1 depicts an exemplary architectural topology for practicing embodiments of the present invention.

FIG. 2 depicts information flow in accordance with the present invention.

FIG. 3 depicts a schematic diagram of an exemplary hierarchical approach in accordance with the present invention.

FIG. 4 illustrates an exemplary series of steps consistent with the principles of the present invention.

### DETAILED DESCRIPTION

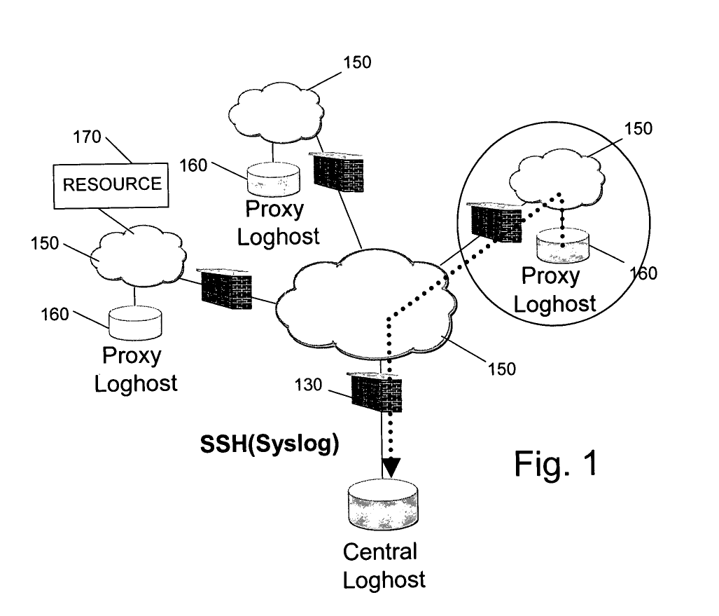

The basic architectural topology of the present invention is depicted in FIG. 1. A central loghost 100 is in communication with a network 150, preferably via a firewall 130 and is configured to receive “events.” Also shown are a plurality of proxy loghosts 160 that collect log file information and generate events, as will be discussed in detail below.

Connected to network 150 are several “resources” 170. In the context of this description, a “resource” is to be construed broadly to include individual computers, routers, networked applications, firewalls 130, and virtually any “system” that may be connected to (or operating within) a given network and that generates log files. As described previously, many enterprise software applications, network resources, routers, firewalls and the like generate log files for their own respective uses. Typically, log files are generated to facilitate trouble-shooting and to monitor the status of a given resource. In accordance with embodiments of the present invention, log files from substantially all of the resources 170 that generate log files, and that may be in communication with a respective network 150, are forwarded, preferably continually, to a corresponding proxy loghost 160. As will be explained more fully below, these log files are then analyzed and “events” are generated. The events are then forwarded to central loghost 100 for further analysis.

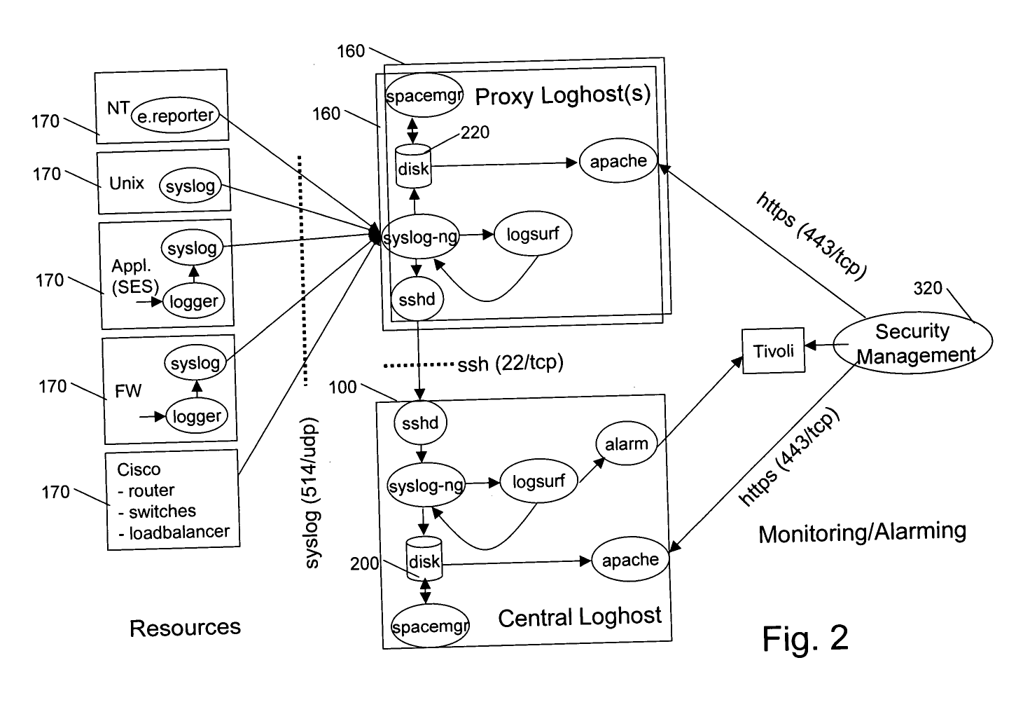

Referring to FIG. 2, proxy loghosts 160 may be Unix-based applications that have access to a memory store such as a disk drive 220. Preferably, incoming log file data is in a standard “syslog” format. When necessary, software adapters can be used to convert other log data formats (e.g., “logger” and “snmptrapd”) to the syslog format. As shown in FIG. 2, several proxy loghosts 160 can be connected to central loghost 100. In a preferred implementation, communication between proxies and central loghost 100 is encrypted.

In the implementation shown, both proxy and central loghosts are independent modules. Accordingly, they can run on the same overall system. Due to the volume of log files that may be available from different parts of an enterprise, proxy loghosts 160 can be configured to store log files for a given time period. Proxy loghosts 160 may also perform some pre-selected portion of the processing that might normally be performed by central loghost 100, and then forward results of the processing to central log host 100. In either case, proxy loghost 160 preferably maintains a local copy of the log files received, along with whatever other data that might be forwarded to central loghost 100.

In a preferred implementation, stored log files and event files (to be described later herein) can be remotely accessed on proxy loghosts 160 and central log hosts 100 using https. Also, log files are preferably automatically rotated and archived on disk drive 220. When an alarm (to be described later herein) is generated, it is sent to, for example, a Tivoli console for display to a network security manager.

The following describes the several software modules that comprise central loghost 100 and proxy loghosts 160. In an actual implementation, the basic operating system is based on a Solaris Operating System operating in a 64-bit mode. Of course, other Unix-styled systems such as Linux may also be employed. A space manager (spacemgr) controls disks 200/220 to archive and rotate files on “data” and “archive” attritions of the drives. To maintain a reasonal partition of disks 220, daily log files are compressed and archived, thereby keeping the system relatively manageable.

A secure shell daemon (sshd) operates to exchange data between proxy loghosts 160 and central loghost 100. “syslog-ng” collects, stores and forwards data (syslog, events) to disks 200/220 and/or to a “logsurf” application. The syslog-ng operating on proxy log hosts 160 is somewhat different from the same module operating on central log host 100 in that the syslog-ng operating on proxy loghosts 160 is configured to receive log files and then forward event files to central loghost 100.

Logsurf is provided as a real-time log file analysis module that generates events and alerts. This module is preferably programmed to monitor the collected log files for unusual patterns, strings and/or signatures. In other words, the logsurf module analyzes the incoming log files for anomalies that may occur due to, for example, viruses, denial of service attacks and unauthorized intruders. Logsurf is also preferably programmed to detect and analyze other information that can be gleaned from a stream of log files obtained from systems and resources throughout a network.

The apache module is provided for visualization of log files and events via https. The alarm module provides alarm information to a security manager when the logsurf module makes a determination of an unexpected pattern of events, signatures and/or other anomaly from the events received.

Syslog messages received by proxy log hosts 160 are preferably grouped and stored in different files according to their type. Type classification simplifies access to the log messages on the proxy loghosts for later analysis. To be as useful as possible, the present invention preferably processes all syslog messages, regardless of their type, to detect security events. Examples of syslog message types include firewall messages and web server messages.

In some instances, applications do not include their own syslog forwarding capabilities. In such a case, as is depicted in FIG. 2 with respect to two of the resources 170 shown therein (firewall-FW and Appl-SES), external logging programs (“logger”) are used to forward the messages from the application to a local syslog daemon that subsequently forwards them to the remote proxy loghost.

### Event Configuration

To identify events in the context of analyzing log files, the present invention operates as follows. The logsurf module is configured to identify log messages containing “interesting,” unexpected or unconventional information that can be used to generate an event. Such interesting information might include pattern matching and/or the volume of log messages received over a predetermined period of time. Each event is preferably assigned an event ID, an event description and is annotated with information regarding the application that caused the event generation.

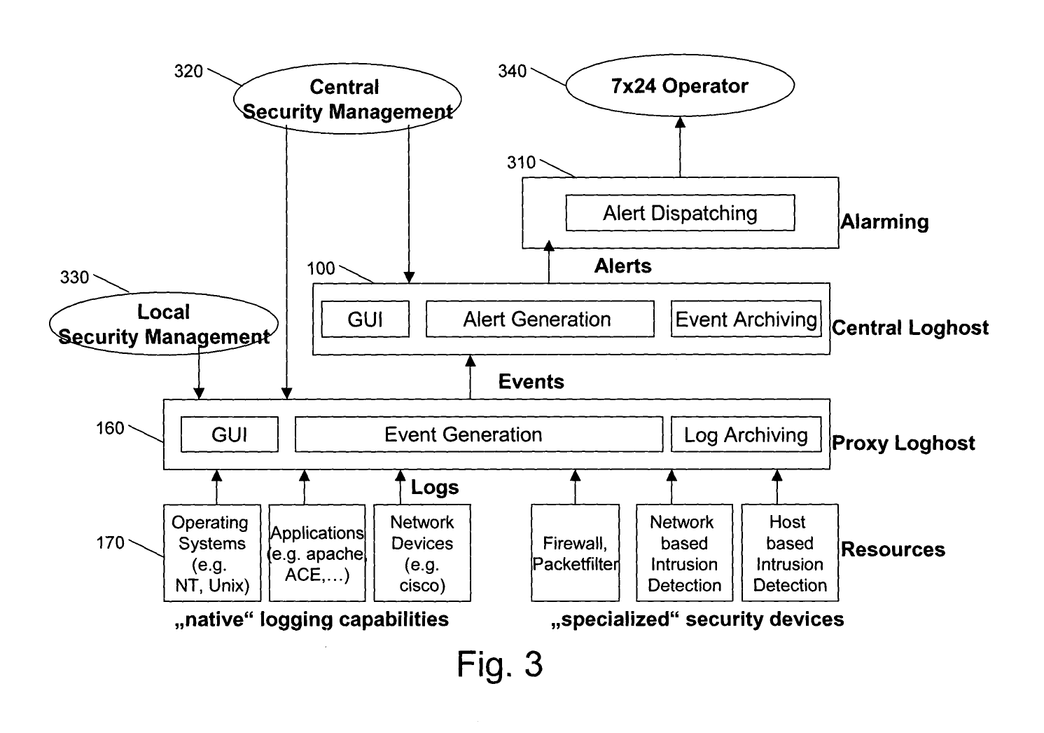

As shown in FIG. 3, resources 170 each generate and forward log files to proxy loghost 160. The received log files are analyzed and, based on that analysis, events are generated. These events are passed to central loghost 100. Proxy loghost preferably has log archiving capabilities as mentioned, and may also have a graphical user interface (GUI) via which local security management personnel 330 can monitor the incoming log files at proxy loghost 160 and any associated generated events. In some cases, local security management personnel can take defensive actions even before the events are passed to central loghost 100. Action may also be taken in parallel by both a local administrator 330 and central security management 320 as events are preferably available at both proxy loghosts and central loghost substantially simultaneously.

Once the events are passed to central loghost 100, alerts are generated based on whether predetermined combinations of events are detected. Central loghost 100 may also analyze the incoming events in an attempt to correlate the type of incoming events being received from different proxy loghosts or a selected proxy loghost. In some cases, several events may be necessary to collect enough information to generate a particular alert. In such a case, the alert is known as a “context” based alert. As shown, central loghost 100 preferably includes event archiving capabilities and a GUI via which central security management personnel 320 may monitor the flow of alerts. Preferably, central security management personnel also have access to the GUI associated with proxy loghost 160.

Alerts are passed to an alarming module 310 via which the alerts can be dispatched to an operator who is preferably continuously on duty. Alarming can be in the form of emails, telephone calls, or any available communication type.

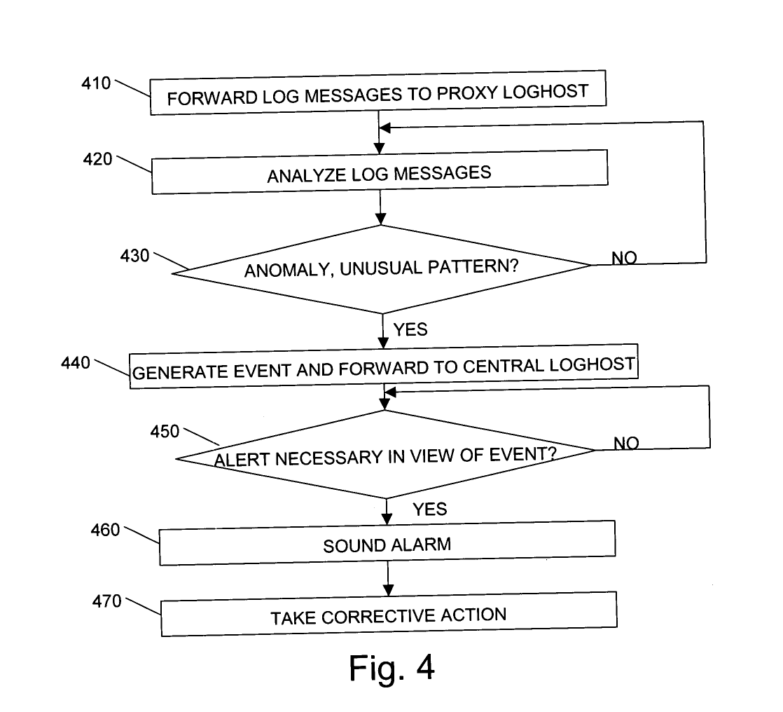

FIG. 4 illustrates a series of steps in accordance with the present invention. As shown, at step 410 log messages are forwarded to a proxy loghost. At step 420, the log messages are analyzed. At step 430 it is determined whether any anomalies or unusual patterns are being detected in the log files received. If none is detected, the process continues to analyze the incoming log files. If an anomaly of some kind is detected, based on, e.g., an unexpected type of log file, or the volume of log files over a given period of time, then at step 440, an event is generated and forwarded to the central loghost. The central loghost monitors the received events and, when appropriate, determines at step 450 whether an alert should be generated in view of the received events. If no alert is necessary, then the central loghost continues to analyze the events. If an alert is indicated, then at step 460 an alarm is “sounded” by way of, e.g., a GUI, email, or other method. Thereafter, at step 470, corrective action is preferably taken to address the cause of the alert.

Thus, as will be readily appreciated by those skilled in the art, the present invention provides systems and methods by which security managers can effectively monitor substantially all of the components of a network using information (log files) that is already being generated by the individual components of the network. Consequently, it is unnecessary to invest in expensive network-based or host-based monitoring systems that may only be partially effective in any event. On the other hand, to the extent such network-based or host-based systems have already been implemented, any log files generated by such systems can also be forwarded to a proxy loghost (as shown in FIG. 3).

In some cases an enterprise may be sufficiently small as to not justify implementing proxy loghosts. In such a case, the central loghost is preferably configured to received the log files directly, and both generate and analyze events.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A monitoring/intrusion detection system, comprising:
a central loghost,
at least one proxy loghost in communication with the central loghost; and
at least one monitoring station,
wherein the proxy loghost receives a plurality of log files from a plurality of resources operating on a network, analyzes the log files for at least one of unexpected volume, unexpected patterns, or unexpected types of log files, and generates events in view of such analysis,
wherein the central loghost is operable to receive the events generated by the proxy loghost and generate an alert upon an analysis of the events, and
wherein the monitoring station is caused to issue an alarm when the alert is generated.

2. The system of claim 1, wherein the central loghost comprises a plurality modules operating in a Unix environment.

3. The system of claim 1, further comprising a plurality of proxy loghosts, each one of the plurality being in communication with the central loghost.

4. The system of claim 1, wherein the resources comprise at least one of an operating system, application, firewall, router, switch and loadbalancer.

5. The system of claim 1, wherein a plurality of events is required to cause the generation of an alert.

6. The system of claim 1, wherein security management has access to both the proxy loghost and the central loghost.

7. The system of claim 1, wherein the log files are received from a network-based intrusion detection system.

8. The system of claim 1, wherein the log files are received from a host-based intrusion detection system.

9. The system of claim 1, wherein the log files are archived on the proxy loghost and the events are archived on the central loghost.

10. The system of claim 1, further comprising software adapters to convert one format of a log file to another format.

11. The system of claim 1, further comprising a module for visualizing the log files received at the proxy loghost.

12. A system for detecting intrusion into a secure network, comprising:
a plurality of proxy loghosts, each proxy loghost collecting log files that are generated by resources in a portion of the secure network, the plurality of loghosts generating events in response to the log files collected; and
a central loghost in communication with the plurality of proxy loghosts, the central loghost receiving at least one of (i) the log files themselves and (ii) the events from the plurality of proxy loghosts, the central loghost analyzing the events to determine the necessity of generating an alert and an associated alarm to notify a security manager of a possible intrusion incident.

13. The system of claim 12, wherein the central loghost comprises a plurality modules operating in a Unix environment.

14. The system of claim 12, wherein the resources comprise at least one of an operating system, application, firewall, router, switch and loadbalancer.

15. The system of claim 12, wherein a plurality of events is required to cause the generation of an alert.

16. The system of claim 12, wherein security management has access to both the plurality of proxy loghosts and the central loghost.

17. The system of claim 12, wherein the log files are received from a network-based intrusion detection system.

18. The system of claim 12, wherein the log files are received from a host-based intrusion detection system.

19. The system of claim 1, wherein the log files are archived on the plurality of proxy loghosts and events are archived on the central loghost.

20. The system of claim 12, further comprising software adapters to convert one format of a log file to another format.

21. The system of claim 12, further comprising a module for visualizing the log files received at the proxy loghost.

22. A method of monitoring a network, comprising:
receiving a plurality of log messages at a proxy loghost;
analyzing the log messages and determining whether, in the log files, there exists any anomalies or unusual patterns;
generating an event in response to the anomalies or unusual patterns and forwarding the event to a central loghost;
monitoring the events at the central loghost and generating an alert in accordance with predetermined event analysis; and
sounding an alarm in coordination with the alert, the alarm being indicative of an unwanted incident in the network.

23. The method of claim 22, wherein the central loghost comprises a plurality modules operating in a Unix environment.

24. The method of claim 22, wherein a plurality of proxy loghosts receive log files.

25. The method of claim 22, wherein the log files are received from resources comprising at least one of an operating system, application, firewall, router, switch and loadbalancer.

26. The method of claim 22, further comprising generating the alert only after a plurality events are received.

27. The method of claim 22, further comprising remotely accessing, from a single location, both the proxy loghost and the central loghost.

28. The method of claim 22, wherein the log files are received from a network-based intrusion detection system.

29. The method of claim 22, wherein the log files are received from a host-based intrusion detection system.

30. The method of claim 22, further comprising archiving the log files on the proxy loghost and archiving the event on the central loghost.
